(19) United States
(12) Patent Application Publication
(10) Pub. No.: US 2024/0372690 A1
(43) Pub. Date: Nov. 7, 2024

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventor: Jinqiang XING, Dongguan (CN)

(21) Appl. No.: 18/774,888

(22) Filed: Jul. 16, 2024

Related U.S. Application Data
(63) Continuation of application No. PCT/CN2022/075240, filed on Jan. 30, 2022.

(51) Int. Cl. H04L 5/00; H04W 72/0453

(52) U.S. Cl. CPC H04L 5/0098; H04L 5/0046; H04L 5/0048; H04W 72/0453

(57) ABSTRACT

Provided is a wireless communication method. The method is applicable to a terminal device, and includes: transmitting first information to a network device, wherein the first information includes target carriers and/or target bandwidth parts (BWPs) corresponding to a plurality of transmit links of the terminal device, wherein the target carriers and/or the target BWPs corresponding to the plurality of transmit links are configured to determine reference direct current (DC) carrier positions corresponding to the plurality of transmit links.

### CROSS-REFERENCE TO RELATED APPLICATION

This application is a continuation of International Application No. PCT/CN2022/075240, filed Jan. 30, 2022, the entire disclosure of which is incorporated herein by reference.

### TECHNICAL FIELD

Embodiments of the present disclosure relate to the field of communications, and in particular, relate to a wireless communication method, a terminal device, and a network device.

### BACKGROUND

In communication systems, a terminal device may report direct current (DC) carrier positions (DC positions for short) to a network device such that the network device achieves interference cancellation. In some scenarios, in the case that the terminal device uses a plurality of transmit links to support carrier aggregation (CA) of a plurality of carriers, the terminal device runs on the plurality of carriers, and each of the plurality of is configured with a plurality of bandwidth parts (BWPs).

### SUMMARY

Embodiments of the present disclosure provide a wireless communication method, a terminal device, and a network device.

In some embodiments of the present disclosure, a wireless communication method is provided. The method includes: transmitting, by a terminal device, first information to a network device, wherein the first information includes target carriers and/or target BWPs corresponding to a plurality of transmit links of the terminal device, wherein the target carriers and/or the target BWPs corresponding to the plurality of transmit links are configured to determine reference DC positions corresponding to the plurality of transmit links.

In some embodiments of the present disclosure, a wireless communication method is provided. The method includes: receiving, by a network device, first information from a terminal device, wherein the first information includes target carriers and/or target BWPs corresponding to a plurality of transmit links of the terminal device, wherein the target carriers and/or the target BWPs corresponding to the plurality of transmit links are configured to determine reference DC positions corresponding to the plurality of transmit links.

In some embodiments of the present disclosure, a terminal device is provided. The terminal device is configured to perform the method in the above embodiments.

In particular, the terminal device includes functional modules configured to perform the method in the above embodiments thereof.

In some embodiments of the present disclosure, a network device is provided. The network device is configured to perform the method in the above embodiments thereof.

In particular, the network device includes functional modules configured to perform the method in the above embodiments thereof.

In some embodiments of the present disclosure, a terminal device is provided. The terminal device includes: a processor and a memory storing one or more computer programs; wherein the processor, when loading and running the one or more computer programs in the memory, is caused to perform the method in the above embodiments thereof.

In some embodiments of the present disclosure, a network device is provided. The network device includes: a processor and a memory storing one or more computer programs; wherein the processor, when loading and running the one or more computer programs in the memory, is caused to perform the method in the above embodiments thereof.

In some embodiments of the present disclosure, a chip is provided. The chip is configured to perform the method in any of the above embodiments thereof. In particular, the chip includes: a processor, wherein the processor is configured to load and run one or more computer programs in the memory to cause a device equipped with the chip to perform the method in any of the above embodiments thereof.

In some embodiments of the present disclosure, a computer-readable storage medium is provided. The computer-readable storage medium is configured to store one or more computer programs, wherein the one or more computer programs, when loaded and run by a computer, cause the computer to perform the method in any of the above embodiments thereof.

In some embodiments of the present disclosure, a computer program product is provided. The computer program product includes one or more computer program instructions, wherein the one or more computer program instructions, when loaded and run by a computer, cause the computer to perform the method in any of the above embodiments thereof.

In some embodiments of the present disclosure, a computer program is provided. The computer program, when loaded and run by a computer, causes the computer to perform the method in any of the above embodiments thereof.

### BRIEF DESCRIPTION OF DRAWINGS

FIG. 1 is a schematic diagram of a communication system architecture according to some embodiments of the present disclosure;

FIGS. 2 is a schematic diagram of signal modulation according to some embodiments of the present disclosure;

FIG. 3 is a schematic diagram of signal modulation spectrum according to some embodiments of the present disclosure;

FIG. 4 is a schematic structural diagram of an inner of a terminal device according to some embodiments of the present disclosure;

FIG. 5 is a schematic diagram of BWP configuration;

FIG. 6 is a schematic diagram of reporting DC positions based on BWPs;

FIG. 7 is a schematic diagram of BWP configuration in a CA scenario;

FIG. 8 is a schematic diagram of interactions of a wireless communication method according to some embodiments of the present disclosure;

FIG. 9 is a schematic diagram of offsets of reference DC positions and DC positions corresponding to transmit links according to some embodiments of the present disclosure;

FIG. 10 is a schematic diagram of reference DC positions according to some embodiments of the present disclosure;

FIG. 11 is a schematic block diagram of a terminal device according to some embodiments of the present disclosure;

FIG. 12 is a schematic block diagram of a network device according to some embodiments of the present disclosure;

FIG. 13 is a schematic block diagram of a communication device according to some embodiments of the present disclosure;

FIG. 14 is a schematic block diagram of a chip according to some embodiments of the present disclosure; and

FIG. 15 is a schematic block diagram of a communication system according to some embodiments of the present disclosure.

### DETAILED DESCRIPTION

The technical solutions according to the embodiments of the present disclosure are described hereinafter in combination with the accompanying drawings in the embodiments of the present disclosure. It is obvious that the described embodiments are merely part but not all of the embodiments of the present disclosure. All other embodiments derived by those skilled in the art without creative efforts based on the embodiments in the present disclosure are within the protection scope of the disclosure.

The technical solutions according to the embodiments of the present disclosure are applicable to various communication systems, for example, a global system of mobile communication (GSM), a code division multiple access (CDMA) system, a wideband code division multiple access (WCDMA) system, a general packet radio service (GPRS), a long-term evolution (LTE) system, an advanced long-term evolution (LTE-A) system, a new radio (NR) system, an evolution system of an NR system, an LTE-based access to unlicensed spectrum (LTE-U) system, an NR-based access to unlicensed spectrum (NR-U) system, a non-terrestrial networks (NTN) system, an universal mobile telecommunication system (UMTS), a wireless local area networks (WLAN), a wireless fidelity (Wi-Fi), a 5^{th} generation (5G) communication system, and other communication systems.

In general, a conventional communication system supports a limited number of connections and is easy to implement. However, with the development of communications technologies, the mobile communication system supports traditional communications and other communications, for example, device-to-device (D2D) communications, machine-to-machine (M2M) communications, machine type communications (MTC), vehicle-to-vehicle (V2V) communications, vehicle-to-everything (V2X) communications, and the like. The communication systems are applicable to the embodiments of the present disclosure.

In some embodiments, the communication system in the embodiments of the present disclosure is applicable to a CA scenario, a dual connectivity (DC) scenario, and a standalone (SA) networking scenario.

In some embodiments, the communication system in the embodiments of the present disclosure is applicable to an unlicensed spectrum. The unlicensed spectrum is also construed as a shared spectrum. Alternatively, the communication system in the embodiments of the present disclosure is applicable to a licensed spectrum. The licensed spectrum is also construed as a non-shared spectrum.

The embodiments of the present disclosure are described in conjunction with the network device and the terminal device. The terminal device is also referred to as a user equipment (UE), an access terminal, a subscriber unit, a subscriber station, a mobile station, a mobile, a remote station, a remote terminal, a mobile device, a user terminal, a terminal, a wireless communication device, a user proxy, a user device, or the like.

The terminal device may be a station (ST) in the WLAN, a cellular phone, a cordless phone, a Session Initiation Protocol (SIP) phone, a wireless local loop (WLL) ST, a personal digital assistant (PDA), a hand-held device with the wireless communication capability, a computing device or other processing devices connected to a wireless modem, an in-vehicle device, a wearable device, a next generation communication system, such as a terminal device in the NR network, or a terminal device in an evolved public land mobile network (PLMN) network.

In the embodiments of the present disclosure, the terminal device is deployed on land, where the deployment includes indoors or outdoors, or handheld, wearable, or vehicle-mounted deployment; or the terminal device may be deployed on water (for example, on a ship); or the terminal device may be deployed in air (for example, on an aircraft, a balloon, or a satellite).

In the embodiments of the present disclosure, the terminal device is a mobile phone, a pad, a computer with a radio transceiver function, a virtual reality (VR) terminal, an augmented reality (AR) terminal, an wireless terminal in industrial control, a wireless terminal in self-driving, a wireless terminal in telemedicine (remote medical surgeries), a wireless terminal in smart grid, a wireless terminal in transportation safety, a wireless terminal in smart city, or a wireless terminal device in smart home.

As examples instead of limitations, in the embodiments of the present disclosure, the terminal device may be a wearable device. The wearable device may also be referred to as a wearable smart device, and is a generic name for wearable devices such as glasses, gloves, watches, clothes, and shoes that are developed by applying wearable technologies for smart designs of daily wear. The wearable device is a portable device that is directly worn on a body or integrated into clothing or an accessory of a user. The wearable device is not only a hardware device, but also implements powerful function by software support, data exchange, and cloud interaction. In a broad sense, the wearable smart device includes a device with full functionality and a large size that is capable of implementing all or part of functions without relying on a smart phone, for example, a mart watch or smart glasses; and includes a device that specializes in specific application functions and needs to be used with another device such as a smart phone, for example, various smart bracelets or smart jewelry for vital sign monitoring.

In the embodiments of the present disclosure, the network device is a device for communicating with the mobile device, the network device is an access point (AP) in WLAN, a base transceiver station (BTS) in GSM or CDMA, an NodeB (NB) in WCDMA, an evolved NodeB (cNB or eNodeB) in LTE, a relay station or an AP, an in-vehicle device, a wearable device, a network device in an NR network (gNB) or in a future evolutional PLMN network or an NTN network.

As examples and not limitations, the terminal device is mobile in the embodiments of the present disclosure. For example, the network device is a mobile device. In some embodiments, the network device is a satellite or a balloon station. For example, the satellite is a low Earth orbit (LEO) satellite, a medium Earth orbit (MEO) satellite, a geostationary Earth orbit (GEO) satellite, a high elliptical orbit (HEO) satellite, or the like. In some embodiments, the network device is also an NB located on land, water, or the like.

In the embodiments of the present disclosure, the network device provides services for cells, and the terminal device communicates with the network device over the transmission resources (such as the frequency domain resources, or the spectrum resources) used in the cells. The cell is a cell corresponding to the network device (such as the NB), and the cell belongs to a macro NB or a NB corresponding to a small cell. The small cell includes a metro cell, a micro cell, a pico cell, a femto cell, or the like. The small cells have the small coverage and low transmission power, and are suitable for providing high rate data transmission services.

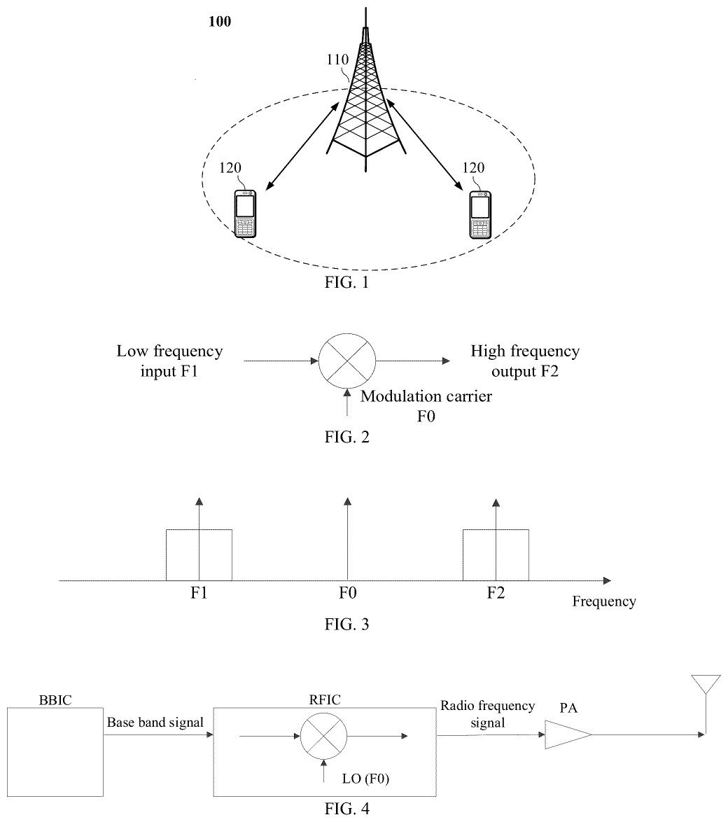

Illustratively, the communication system 100 in the embodiments of the present disclosure is shown in FIG. 1. The communication system 100 includes a network device 110, and the network device is a device that communicates with a terminal device 120 (also referred to as a communication terminal or a terminal). The network device 110 provides communication coverage to a specific geographical area, and communicates with the terminal device in the coverage arca.

FIG. 1 illustrates one network device and two terminal devices. In some embodiments, the communication system 100 includes a plurality of network devices, and another quantity of terminal devices are included within a coverage range of each of the network devices, which is not limited in the embodiments of the present disclosure.

In some embodiments, the communication system 100 further includes another network entity such as a network controller, a mobile management entity, or the like, which is not limited in the embodiments of the present disclosure.

It should be noted that devices with the communication function in the network/system in the embodiments of the present disclosure are referred to as the communication devices. By taking the communication system 100 shown in FIG. 1 as an example, the communication device includes the network device 110 and the terminal device 120 that have the communication function, and the network device 110 and the terminal device 120 are specific devices as described above, which are not repeated herein. The communication device further includes another device in the communication system 100, for example, another network device such as a network controller, a mobile management entity, or the like, which is not limited in the embodiments of the present disclosure.

It should be understood that the terms “system” and “network” herein are interchangeably used in this document. The term “and/or” herein merely indicates an association relationship describing associated objects, that is, three types of relationships. For example, the phrase “A and/or B” indicates (A), (B), or (A and B). In addition, the character “/” generally indicates an “or” relationship between the associated objects.

It should be understood that the term “indicate” in the embodiments of the present disclosure means the direct indication, indirect indication, or an associated relationship. For example, A indicating B means that A directly indicates B, for example, B is acquired by A; A indirectly indicates B, for example, A indicates C and B is acquired by C; A and B are associated.

In the description of the embodiments of the present disclosure, the term “corresponding” mean that there is a direct correspondence or indirect correspondence between two objects, an association relationship between two objects, an indicating and indicated relationship, or a configuring and configured relationship.

In the embodiments of the present disclosure, the “predefinition” is achieved by pre-storing corresponding codes or forms in the device (for example, including the terminal device and the network device) or other means for indicating relevant information, and the specific implementations are not limited in the present disclosure. For example, the predefinition is defined in the protocol.

In the embodiments of the present disclosure, the “protocol” indicates standard protocols in the field of communications, for example, the LTE protocol, the NR protocol, and related protocols applied to the future communication system, which are not limited in the present disclosure.

For better understanding of the embodiments of the present disclosure, the related technologies are illustrated hereinafter.

In the wireless communication, signal spectrum shift is mainly achieved by modulation. For example, as shown in FIG. 2, a non-linear operation is performed on a low frequency input signal F1 and a modulation carrier F0 by a mixer to generate a sum frequency signal or a difference frequency signal of the two signals, such that a desired high frequency output signal F2 is screened out. That is, spectrum shift from the low frequency to the high frequency is achieved. A frequency relationship is F2=F1+F0.

An intermediate frequency of the wideband signal is the DC carrier position, also referred to as a DC position, for example, F1 and F2 shown in FIG. 3.

In specific implementations, the signal modulation is achieved in a radio frequency integrated circuit (RFIC) of the terminal device. As shown in FIG. 4, a base band integrated circuit (BBIC) of the terminal device inputs a base band signal to the RFIC. Furthermore, in the RFIC, the input low frequency base band signal and a local oscillation signal (LO, with a frequency of FO) are mixed to generate a radio frequency signal, and the radio frequency signal is amplified by a power amplifier (PA) and is transmitted over an antenna of the terminal device.

In the orthogonal frequency-division multiplexing (OFDM) modulation, greater signal interference typically occurs at the DC position, the carrier needs to be removed at a receiver to improve a receive signal-to-noise ratio, and thus the receiver needs to acquire the accurate DC position. The DC position is generally informed by a transmitter to receiver. By taking the uplink transmission as an example, the terminal device needs to inform the network device the accurate DC position of the transmitted signal, such that the network device accurately removes the sub-carriers at the DC position.

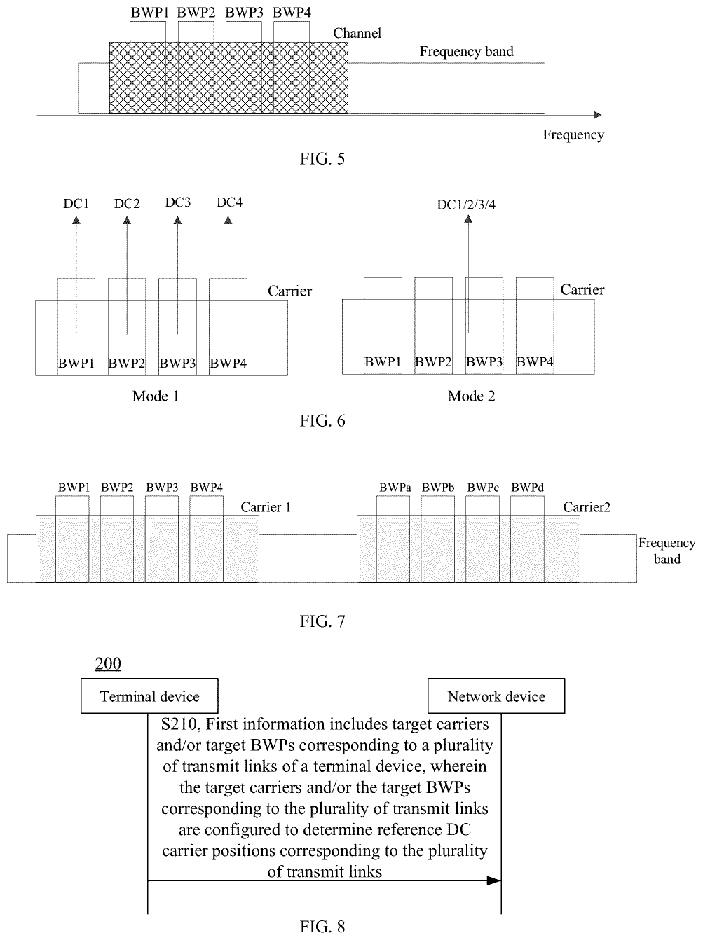

In the NR system, a concept of BWP is introduced to save the power of the terminal, and the network device generally configures a low transmission and reception bandwidth for the terminal device to reduce complexity in transmitting and receiving the signal by the terminal device. For example, a plurality of channels are within the whole frequency band, the network device configures no more than four BWPs (only one BWP is activated in the same time) in the case that the terminal device accesses one channel, and the terminal device runs in the activated BWP in the subsequent channels. The terminal device reports the DC position based on the configured BWPs. Assuming that four BWPs (BWPs 1 to 4) are configured in a single-carrier as shown in FIG. 5, then the terminal device at most reports four DC positions to the network device.

The BWPs configuration is achieved as semi-static configuration by radio resource control (RRC) signaling (for example, RRC reconfiguration), and the BWP activation is achieved by downlink control information (DCI) in a physical downlink control channel (PDCCH), which is dynamic configuration.

In the case that the network device configures the BWPs by the RRC signaling, a minimum operating bandwidth of the radio frequency reception and transmission path of the terminal device is greater than or equal to the width of the BWP, and the specific implementations are determined by the terminal device.

As shown in FIG. 6, the terminal device adjusts the DC position depending on the position of the activated BWP. For example, in the mode 1 shown in FIG. 6, different BWPs correspond to respective DC positions, and different DC positions are used in activating different BWPs. In some embodiments, the terminal reports the same DC position for all activated BWPs. For example, in the mode 2 shown in FIG. 6, the same DC position is used regardless of which BWP is activated.

In some scenarios, the terminal device reports corresponding DC positions based on BWPs. For the single-carrier, the terminal device at most reports four DC positions of the activated BWPs to the network device.

For simultaneous operations of multiple intra-band carriers, a total number of BWPs is multiplied depending on an increase of the number of carriers. By taking intra-band CA as an example, the terminal device generally supports the whole bandwidth by using one transmit link. As shown in FIG. 7, in the case that the network device is configured with two carriers (the carrier 1 and the carrier 2), cach carrier is configured with four BWPs, the carrier 1 is configured with BWPs 1 to 4, and the carrier 2 is configured with a BWP a to a BWP d.

In general, for the case that the intra-band CA is supported by a single transmit link, the terminal device modulates two activated BWPs together to achieve the spectrum shift, that is, only one DC position is provided. As such, in the case of two carriers, potential BWP combinations have 4×4=16 combinations, and the corresponding 16 potential DC positions are present. As the number of carriers in the CA increases, the number of activated BWP combinations is also multiplied. In the case that the DC position is still reported based on the BWP (or a combination of BWPs), the potential DC positions is also multiplied, such that a signaling overhead is great.

For the case that the intra-band CA is supported by multi transmit links, the DC positions of the terminal device are more complex.

Thus, in the case that the CA is supported by multiple transmit links, how to report the DC positions by the network device is an urgent problem to be solved. It should be noted that in the embodiments of the present disclosure, the sequence numbers of processes do not mean the execution order, the execution order of the processes shall be determined based on functions and internal logic, and thus the sequence numbers shall not be construed as any limitation on the implementation processes of the embodiments of the present disclosure.

It should be noted that the embodiments and/or the technical features in the embodiments of the present disclosure can be arbitrarily combined with each other without conflict, and the technical solutions acquired by combining shall also fall within the scope of protection of the present disclosure.

FIG. 8 is a schematic diagram of interactions of a wireless communication method according to some embodiments of the present disclosure. as shown in FIG. 8, the method 200 includes at least part of the following processes.

In S210, a terminal device transmits first information to a network device, wherein the first information includes target carriers and/or target BWPs corresponding to a plurality of transmit links of the terminal device, wherein the target carriers and/or the target BWPs corresponding to the plurality of transmit links are configured to determine reference DC carrier positions corresponding to the plurality of transmit links.

In some embodiments, the first information is transmitted over any of the above uplink messages or uplink signaling, for example, an uplink RRC message, a medium access control (MAC) signaling, a physical uplink control channel (PUCCH), and the like, which is not limited in the present disclosure.

In the embodiments of the present disclosure, the terminal device runs on a plurality of carriers simultaneously. For example, the terminal device is configured in a CA (for example, including an intra-band contiguous CA and an intra-band non-contiguous CA) or DC operation mode.

In the embodiments of the present disclosure, the terminal device uses a plurality of transmit links to support to run on the plurality of carriers simultaneously. In other words, the terminal device is in a multi transmit link architecture. In other words, the plurality of carriers correspond to the plurality of transmit links.

In the embodiments of the present disclosure, the transmit link is configured to achieve modulation and power amplification of the carrier signal, and includes the PA and the mixer. In some embodiments, the transmit link architecture indicates a PA architecture.

In the embodiments of the present disclosure, each of the plurality of transmit links corresponds to one DC position. In other words, the terminal devices support a plurality of DC positions. The DC position is a DC position actually used in the transmit link by the terminal device, and is denoted as a target DC position.

In the embodiments of the present disclosure, each of the plurality of transmit links corresponds to one DC position, and the target DC position corresponding to the each of the plurality of transmit links is determined based on the reference DC position and the DC position offset corresponding to the each of the plurality of transmit links. The DC position offset indicates a frequency offset of the DC position actually used in the transmit link by the terminal device relative to the reference DC position.

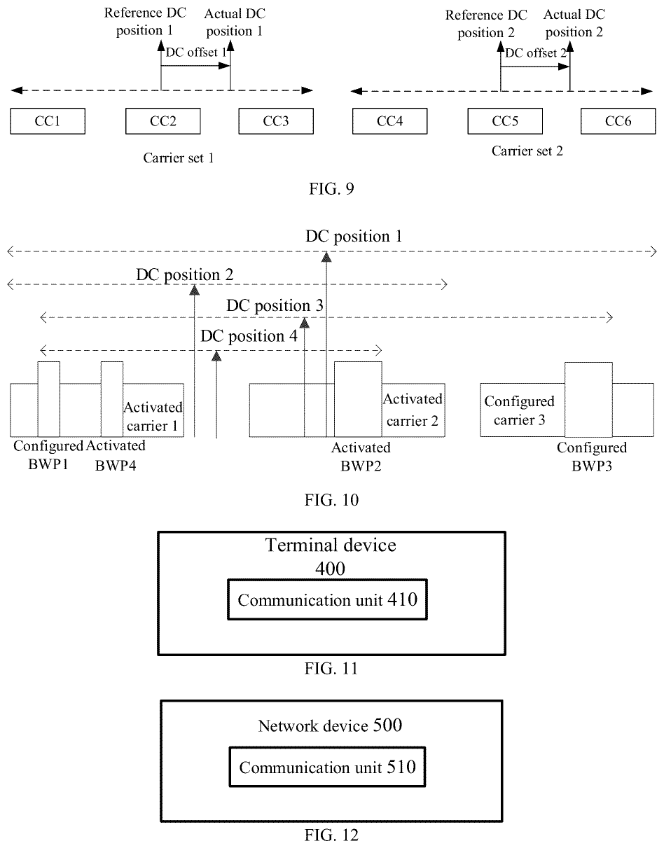

For example, as shown in FIG. 9, the terminal device is configured with the carriers 1 to 6. The carriers 1 to 3 correspond to a transmit link 1, the carriers 4 to 6 correspond to a transmit link 2, and the transmit link 1 and the transmit link 2 respectively correspond to the reference DC positions and the DC offsets thereof. For example, the transmit link 1 corresponds to the reference DC position 1 and the DC offset 1, and the transmit link 2 corresponds to the reference DC position 2 and the DC offset 2.

In some embodiments, the terminal device further transmits second information to the network device. The second information includes DC carrier position offsets corresponding to the plurality of transmit links, and the DC carrier position offsets corresponding to the plurality of transmit links indicate frequency offsets of target DC carrier positions used in the plurality of transmit links by the terminal device relative to the reference DC carrier positions corresponding to the plurality of transmit links. In this case, the target DC position corresponding to each of the transmit links is determined based on the reference DC position and the DC position offset corresponding to the each of the transmit links.

In some embodiments, the plurality of transmit links correspond to a same DC position offset. In this case, the target DC position corresponding to each of the transmit links is determined based on the reference DC position corresponding to the each of the transmit links and the same DC position offset.

It should be understood that the representing mode of the DC position offset is not limited in the embodiments of the present disclosure. The DC position offset is positive, negative, or 0.

In some embodiments, the DC position offset is a specific offset frequency value, for example, 5 kHz, 15 kHz, and the like.

In some embodiments, the DC position offset is an offset sub-carrier number, for example, n sub-carriers offset with per 15 kHz sub-carrier spacing. n is positive, negative, or 0.

In some embodiments, the DC position offset is an offset number with a unit of a specific frequency spacing, for example, n frequency spacing offset per 100 kHz, 5 kHz, 15 kHz, or 200 KHz frequency spacing. n is positive, negative, or 0.

In some embodiments, the second information is transmitted over any of the above uplink messages or uplink signaling, for example, an uplink RRC message, MAC signaling, a PUCCH, or the like, which is not limited in the present disclosure.

In some embodiments, the first information and the second information are transmitted over same signaling or different signaling.

In some embodiments, in the case that the terminal device does not transmit the second information to the network device, or the second information does not include a DC carrier position offsets corresponding to a transmit link, the reference DC position corresponding to the transmit link is the target DC position corresponding to the transmit link by default.

It should be noted that as the transmit links are in one-to-one correspondence with the target DC positions, and the transmit links are in one-to-one correspondence with the reference DC positions, in the embodiments, the target carrier and/or the target BWP corresponding to each of the transmit links is also referred to as the target carrier and/or the target BWP corresponding to the target DC position or the target carrier and/or the target BWP corresponding to the reference DC position.

In the embodiments of the present disclosure, the terminal device reports the DC position corresponding to each of the transmit links based on the reference DC position and the DC position offset.

For example, the terminal device directly reports the reference DC position corresponding to each of the transmit links, or reports related information for determining the reference DC position corresponding to each of the transmit links, which is not limited in the present disclosure.

In some embodiments, the terminal device determines the reference DC position corresponding to each of the transmit links based on third information. The third information includes at least one of:
carrier configuration supported by each of the transmit links, BWP configuration supported by each of the transmit links, activated carrier configuration in carrier configuration supported by each of the transmit links, or activated BWP configuration in BWP configuration supported by cach of the transmit links.

For example, the terminal device determines the reference DC position corresponding to the transmit link based on the carrier with a lowest frequency and the carrier with a highest frequency in all carriers supported by the transmit link. Assuming that the carrier with the lowest frequency is CC1, and the carrier with the highest frequency is CC2, then the terminal device determines the reference DC position corresponding to the transmit link based on the lowest frequency of the CC1 and the highest frequency of the CC2. For example, an intermediate frequency between the lowest frequency of the CC1 and the highest frequency of the CC2 is determined as the reference DC position corresponding to the transmit link.

For example, the terminal device determines the reference DC position corresponding to the transmit link based on the carrier with a lowest frequency and the carrier with a highest frequency in all carriers supported and activated by the transmit link. Assuming that the carrier with the lowest frequency is CC3, and the carrier with the highest frequency is CC4, then the terminal device determines the reference DC position corresponding to the transmit link based on the lowest frequency of the CC3 and the highest frequency of the CC4. For example, an intermediate frequency between the lowest frequency of the CC3 and the highest frequency of the CC4 is determined as the reference DC position corresponding to the transmit link.

For example, the terminal device determines the reference DC position corresponding to the transmit link based on the BWP with a lowest frequency and the BWP with a highest frequency in all BWPs supported by the transmit link. Assuming that the BWP with the lowest frequency is a BWP 1, and the BWP with the highest frequency is a BWP 2, then the terminal device determines the reference DC position corresponding to the transmit link based on the lowest frequency of the BWP 1 and the highest frequency of the BWP 2. For example, an intermediate frequency between the lowest frequency of the BWP 1 and the highest frequency of the BWP 2 is determined as the reference DC position corresponding to the transmit link.

For example, the terminal device determines the reference DC position corresponding to the transmit link based on the BWP with a lowest frequency and the BWP with a highest frequency in all BWPs supported and activated by the transmit link. Assuming that the BWP with the lowest frequency is a BWP 3, and the BWP with the highest frequency is a BWP 4, then the terminal device determines the reference DC position corresponding to the transmit link based on the lowest frequency of the BWP 3 and the highest frequency of the BWP 4. For example, an intermediate frequency between the lowest frequency of the BWP 3 and the highest frequency of the BWP 4 is determined as the reference DC position corresponding to the transmit link.

In some embodiments, the behavior of determination of the reference DC position corresponding to each of the transmit links based on the third information by the terminal device is determined by the terminal device, indicated by instructions of the network device, or predefined (default).

In the embodiments of the present disclosure, the terminal device reports the first information to the network device. The first information includes related information for determining the reference DC position corresponding to each of the transmit links by the terminal device. For example, the first information includes the target carriers and/or the target BWPs corresponding to the plurality of transmit links. The target carriers and/or the target BWPs corresponding to the plurality of transmit links are configured to determine the reference DC positions corresponding to the plurality of transmit links.

Furthermore, the network device determines the reference DC positions corresponding to the plurality of transmit links based on the target carriers and/or the target BWPs corresponding to the plurality of transmit links, and then determines the target DC positions corresponding to the plurality of transmit links based on the reference DC positions and the DC position offsets corresponding to the plurality of transmit links. For example, a sum of the reference DC position and the DC position offset corresponding to each of the transmit links is determined as the target DC position corresponding to the transmit link.

In some embodiments, the target carrier corresponding to each of the transmit links is determined based on carriers supported by the transmit link.

In some embodiments, the target BWP corresponding to each of the transmit links is determined based on BWPs supported by the transmit link.

In some embodiments, the first information further includes information indicating a number of the plurality of transmit links, information indicating a number of DC carriers supported by the terminal device, or information indicating a number of DC carrier positions supported by the terminal device.

In some embodiments, the method for determining the reference DC position corresponding to each of the transmit links by the network device based on the first information upon acquiring the first information and the method for determining the reference DC position corresponding to each of the transmit links the terminal device are the same. That is, the network device and the terminal device determine the reference DC position corresponding to each of the transmit links in the same way, such that the interference cancellation is efficiently achieved by the network device.

It should be noted that as the transmit links are in one-to-one correspondence with the PAs, or, the transmit links are in one-to-one correspondence with the LOs, information indicating a number of the plurality of transmit links are also referred to as information indicating a number of PAs or information indicating a number of LO supported by the terminal device.

The specific implementations of the target carrier or the target BWP corresponding to each of the transmit links are described hereinafter in combination with specific embodiments.

### First Embodiments

In some embodiments, the target carriers corresponding to the transmit links are determined based on the carriers configured in the terminal device and the carriers supported by the transmit links. In other words, the reference DC positions corresponding to the transmit links are determined based on the carriers configured in the terminal device and the carriers supported by the transmit links.

In Embodiment 1-1, the target carriers corresponding to the transmit links include all carriers supported by the transmit links in carriers configured in the terminal device.

For example, the terminal device is configured with the carriers 1 to 6, and the transmit links of the terminal device include the transmit link 1 and the transmit link 2. The transmit link 1 supports the carriers 1 to 3, and the transmit link 2 supports the carriers 4 to 6. Thus, the first information includes the carrier 1, the carrier 2, and the carrier 3 that correspond to the transmit link 1, and the carrier 4, the carrier 5, and the carrier 6 that correspond to the transmit link 2.

In some embodiments, the first information further includes information indicating a number of DCs supported by the terminal device, for example, two DCs in the above embodiments.

In some embodiments, the first information further includes DC position offsets corresponding to the transmit links.

In Embodiment 1-1, the terminal device determines the reference DC position corresponding to the transmit link based on the carrier with the lowest frequency and the carrier with the highest frequency in the target carriers corresponding to the transmit links. For detailed determination method, reference may be made to related descriptions in the above embodiments. Furthermore, the DC position offset corresponding to the transmit link is determined based on the reference DC position corresponding to the transmit link and the target DC position used in the transmit link by the terminal device.

Correspondingly, the network device determines the reference DC position corresponding to the transmit link based on the target carriers corresponding to the transmit links, and further determines the target DC position corresponding to the transmit link in conjunction with the DC position offset corresponding to the transmit link.

In Embodiment 1-2, the target carrier corresponding to the transmit link includes the carrier with the lowest frequency and the carrier with the highest frequency in all carriers supported by the transmit link in carriers configured in the terminal device.

For example, the terminal device is configured with the carriers 1 to 6 of which the carrier frequencies sequentially increase, and the transmit links of the terminal device include the transmit link 1 and the transmit link 2. The transmit link 1 supports the carriers 1 to 3, and the transmit link 2 supports the carriers 4 to 6. That is, for the transmit link 1, the carrier 1 is the carrier with the lowest frequency, and the carrier 3 is the carrier with the highest frequency; for the transmit link 2, the carrier 4 is the carrier with the lowest frequency, and the carrier 6 is the carrier with the highest frequency. Thus, the first information includes the carrier 1 and the carrier 3 that correspond to the transmit link 1, and the carrier 4 and the carrier 6 that correspond to the transmit link 2.

In some embodiments, the first information further includes information indicating a number of DCs supported by the terminal device, for example, two DCs in the above embodiments.

In some embodiments, the first information further includes DC position offsets corresponding to the transmit links.

In Embodiment 1-2, the terminal device determines the reference DC position corresponding to the transmit link based on the carrier with the lowest frequency and the carrier with the highest frequency in the target carriers corresponding to the transmit links. For detailed determination method, reference may be made to related descriptions in the above embodiments. Furthermore, the DC position offset corresponding to the transmit link is determined based on the reference DC position corresponding to the transmit link and the target DC position used in the transmit link by the terminal device.

Correspondingly, the network device determines the reference DC position corresponding to the transmit link based on the target carriers corresponding to the transmit links, and further determines the target DC position corresponding to the transmit link in conjunction with the DC position offset corresponding to the transmit link.

### Second Embodiments

In some embodiments, the target carrier corresponding to the transmit link is determined based on the carriers configured and activated in the terminal device and the carriers supported by the transmit link. In other words, the reference DC position corresponding to the transmit link is determined based on the carriers configured and activated in the terminal device and the carriers supported by the transmit link.

In Embodiment 2-1, the target carrier corresponding to the transmit link includes all carriers supported by the transmit link in carriers configured and activated in the terminal device.

For example, the terminal device is configured with the carriers 1 to 6, the activated carriers are the carriers 1 to 5, and the transmit links of the terminal device include the transmit link 1 and the transmit link 2. The transmit link 1 supports the carriers 1 to 3, and the transmit link 2 supports the carriers 4 to 6. That is, the carriers 1 to 3 are activated carriers supported by the transmit link 1, and the carrier 4 and the carrier 5 are activated carriers supported by the transmit link 2. Thus, the first information includes the carrier 1, the carrier 2, and the carrier 3 that correspond to the transmit link 1, and the carrier 4 and the carrier 5 that correspond to the transmit link 2.

In some embodiments, the first information further includes information indicating a number of DCs supported by the terminal device, for example, 2 in the above embodiments.

In some embodiments, the first information further includes DC position offsets corresponding to the transmit links.

In Embodiment 2-1, the terminal device determines the reference DC position corresponding to the transmit link based on the carrier with the lowest frequency and the carrier with the highest frequency in the target carriers corresponding to the transmit links. For detailed determination method, reference may be made to related descriptions in the above embodiments. Furthermore, the DC position offset corresponding to the transmit link is determined based on the reference DC position corresponding to the transmit link and the target DC position used in the transmit link by the terminal device.

Correspondingly, the network device determines the reference DC position corresponding to the transmit link based on the target carriers corresponding to the transmit links, and further determines the target DC position corresponding to the transmit link in conjunction with the DC position offset corresponding to the transmit link.

In Embodiment 2-2, the target carrier corresponding to the transmit link includes the carrier with the lowest frequency and the carrier with the highest frequency in all carriers supported by the transmit link in carriers configured and activated in the terminal device.

For example, the terminal device is configured with the carriers 1 to 6 of which the carrier frequencies sequentially increase, the activated carriers are the carriers 1 to 5, and the transmit links of the terminal device include the transmit link 1 and the transmit link 2. The transmit link 1 supports the carriers 1 to 3, and the transmit link 2 supports the carriers 4 to 6. Thus, the first information includes the carrier 1 and the carrier 3 that correspond to the transmit link 1, and the carrier 4 and the carrier 5 that correspond to the transmit link 2.

In some embodiments, the first information further includes information indicating a number of DCs supported by the terminal device, for example, two DCs in the above embodiments.

In some embodiments, the first information further includes DC position offsets corresponding to the transmit links.

In Embodiment 2-2, the terminal device determines the reference DC position corresponding to the transmit link based on the carrier with the lowest frequency and the carrier with the highest frequency in the target carriers corresponding to the transmit links. For detailed determination method, reference may be made to related descriptions in the above embodiments. Furthermore, the DC position offset corresponding to the transmit link is determined based on the reference DC position corresponding to the transmit link and the target DC position used in the transmit link by the terminal device.

Correspondingly, the network device determines the reference DC position corresponding to the transmit link based on the target carriers corresponding to the transmit links, and further determines the target DC position corresponding to the transmit link in conjunction with the DC position offset corresponding to the transmit link.

### Third Embodiments

In some embodiments, the target BWP corresponding to the transmit link is determined based on the BWPs configured in the terminal device and the BWPs supported by the transmit link. In other words, the reference DC position corresponding to the transmit link is determined based on the BWPs configured in the terminal device and the BWPs supported by the transmit link.

In Embodiment 3-1, the target BWP corresponding to the transmit link includes all BWPs supported by the transmit link in BWPs configured in the terminal device.

For example, the terminal device is configured with the BWPs 1 to 6, and the transmit links of the terminal device include the transmit link 1 and the transmit link 2. The transmit link 1 supports the BWPs 1 to 3, and the transmit link 2 supports the BWPs 4 to 6. Thus, the first information includes the BWP 1, the BWP2, and the BWP 3 that correspond to the transmit link 1, and the BWP 4, the BWP 5, and the BWP 6 that correspond to the transmit link 2.

In some embodiments, the first information further includes information indicating a number of DCs supported by the terminal device, for example, 2 in the above embodiments.

In some embodiments, the first information further includes DC position offsets corresponding to the transmit links.

In Embodiment 3-1, the terminal device determines the reference DC position corresponding to the transmit link based on the BWP with the lowest frequency and the BWP with the highest frequency in the target BWPs corresponding to the transmit links. For detailed determination method, reference may be made to related descriptions in the above embodiments. Furthermore, the DC position offset corresponding to the transmit link is determined based on the reference DC position corresponding to the transmit link and the target DC position used in the transmit link by the terminal device.

Correspondingly, the network device determines the reference DC position corresponding to the transmit link based on the target BWPs corresponding to the transmit links, and further determines the target DC position corresponding to the transmit link in conjunction with the DC position offset corresponding to the transmit link.

In Embodiment 3-2, the target BWP corresponding to the transmit link includes the BWP with the lowest frequency and the BWP with the highest frequency in all BWPs supported by the transmit link in BWPs configured in the terminal device.

For example, the terminal device is configured with the BWPs 1 to 6 of which the BWP frequencies sequentially increase, and the transmit links of the terminal device include the transmit link 1 and the transmit link 2. The transmit link 1 supports the BWPs 1 to 3, and the transmit link 2 supports the BWPs 4 to 6. That is, for the transmit link 1, the BWP 1 is the BWP with the lowest frequency, and the BWP 3 is the BWP with the highest frequency; for the transmit link 2, the BWP 4 is the BWP with the lowest frequency, and the BWP 6 is the BWP with the highest frequency. Thus, the first information includes the BWP 1 and the BWP 3 that correspond to the transmit link 1, and the BWP 4 and the BWP 6 that correspond to the transmit link 2.

In some embodiments, the first information further includes information indicating a number of DCs supported by the terminal device, for example, 2 in the above embodiments.

In some embodiments, the first information further includes DC position offsets corresponding to the transmit links.

In Embodiment 3-2, the terminal device determines the reference DC position corresponding to the transmit link based on the BWP with the lowest frequency and the BWP with the highest frequency in the target BWPs corresponding to the transmit links. For detailed determination method, reference may be made to related descriptions in the above embodiments. Furthermore, the DC position offset corresponding to the transmit link is determined based on the reference DC position corresponding to the transmit link and the target DC position used in the transmit link by the terminal device.

Correspondingly, the network device determines the reference DC position corresponding to the transmit link based on the target BWPs corresponding to the transmit links, and further determines the target DC position corresponding to the transmit link in conjunction with the DC position offset corresponding to the transmit link. Fourth embodiments

In some embodiments, the target BWP corresponding to the transmit link is determined based on the BWPs configured and activated in the terminal device and the BWPs supported by the transmit link. In other words, the reference DC position corresponding to the transmit link is determined based on the BWPs configured and activated in the terminal device and the BWPs supported by the transmit link.

In Embodiment 4-1, the target BWP corresponding to the transmit link includes all BWPs supported by the transmit link in BWPs configured and activated in the terminal device.

For example, the terminal device is configured with the BWPs 1 to 6, the activated BWPs are the BWPs 1 to 5, and the transmit links of the terminal device include the transmit link 1 and the transmit link 2. The transmit link 1 supports the BWPs 1 to 3, and the transmit link 2 supports the BWPs 4 to 6. Thus, the first information includes the BWP 1, the BWP2, and the BWP 3 that correspond to the transmit link 1, and the BWP 4 and the BWP 5 that correspond to the transmit link 2.

In some embodiments, the first information further includes information indicating a number of DCs supported by the terminal device, for example, 2 in the above embodiments.

In some embodiments, the first information further includes DC position offsets corresponding to the transmit links.

In Embodiment 4-1, the terminal device determines the reference DC position corresponding to the transmit link based on the BWP with the lowest frequency and the BWP with the highest frequency in the target BWPs corresponding to the transmit links. For detailed determination method, reference may be made to related descriptions in the above embodiments. Furthermore, the DC position offset corresponding to the transmit link is determined based on the reference DC position corresponding to the transmit link and the target DC position used in the transmit link by the terminal device.

Correspondingly, the network device determines the reference DC position corresponding to the transmit link based on the target BWPs corresponding to the transmit links, and further determines the target DC position corresponding to the transmit link in conjunction with the DC position offset corresponding to the transmit link.

In Embodiment 4-2, the target BWP corresponding to the transmit link includes the BWP with the lowest frequency and the BWP with the highest frequency in all BWPs supported by the transmit link in BWPs configured and activated in the terminal device.

For example, the terminal device is configured with the BWPs 1 to 6 of which the BWP frequencies sequentially increase, the activated BWPs are the BWPs 1 to 5, and the transmit links of the terminal device include the transmit link 1 and the transmit link 2. The transmit link 1 supports the BWPs 1 to 3, and the transmit link 2 supports the BWPs 4 to 6. Thus, the first information includes the BWP 1 and the BWP 3 that correspond to the transmit link 1, and the BWP 4 and the BWP 5 that correspond to the transmit link 2.

In some embodiments, the first information further includes information indicating a number of DCs supported by the terminal device, for example, 2 in the above embodiments.

In some embodiments, the first information further includes DC position offsets corresponding to the transmit links.

In Embodiment 4-2, the terminal device determines the reference DC position corresponding to the transmit link based on the BWP with the lowest frequency and the BWP with the highest frequency in the target BWPs corresponding to the transmit links. For detailed determination method, reference may be made to related descriptions in the above embodiments. Furthermore, the DC position offset corresponding to the transmit link is determined based on the reference DC position corresponding to the transmit link and the target DC position used in the transmit link by the terminal device.

Correspondingly, the network device determines the reference DC position corresponding to the transmit link based on the target BWPs corresponding to the transmit links, and further determines the target DC position corresponding to the transmit link in conjunction with the DC position offset corresponding to the transmit link.

In some embodiments, as the carrier configuration and the BWP configuration are generally the semi-static configuration, in the case that the terminal device determines the reference DC position corresponding to the transmit link based on the carrier configuration or the BWP configuration supported by the transmit link, the terminal device does not need to frequently report the target carrier or the target BWP corresponding to each transmit line and only needs to report the frequency offset of the adjusted DC position relative to the reference DC position in the case that the actually used DC position is adjusted, such that the signaling payload is reduced.

It should be understood that in the above embodiments, methods for determining default DC positions corresponding to the plurality of transmit links are the same or different, which are not limited in the present disclosure. For example, the plurality of transmit links include a first transmit link and a second transmit link, the reference DC position corresponding to the first transmit link is determined based on the target carrier corresponding to the first transmit link, the reference DC position corresponding to the second transmit link is determined based on the target BWP corresponding to the second transmit link, and the like, and thus, for the two transmit links, the first information includes the target carrier corresponding to the first transmit link and the target BWP corresponding to the second transmit link.

In some embodiments, the network device determines the reference DC position corresponding to the transmit link based on the target carrier corresponding to the transmit link. For example, a specific position between the lowest frequency and the highest frequency of the target carrier is determined as the reference DC position, for example, an intermediate frequency position of the target carrier is determined as the reference DC position.

In some embodiments, the network device determines the reference DC position corresponding to the transmit link based on the target BWP corresponding to the transmit link. For example, a specific position between the lowest frequency and the highest frequency of the target BWP is determined as the reference DC position, for example, an intermediate frequency position of the target BWP is determined as the reference DC position.

In conjunction with FIG. 10, the CA is configured with the carrier 1, the carrier 2, and the carrier 3. The carrier 1, the carrier 2, and the carrier 3 correspond to one transmit link, and the carrier 1 and the carrier 2 are activated. The carrier 1 is configured with the BWP 1 and the BWP 4, and the BWP 4 is activated. The carrier 2 is configured with the BWP 2, and the BWP 2 is activated. The carrier 3 is configured with the BWP 3.

That is, for the transmit link, the configured carriers include the carrier 1, the carrier 2, and the carrier 3, the activated carriers include the carrier 1 and the carrier 2, the configured BWPs include the BWPs 1 to 4, and the activated BWPs include the BWP 4 and the BWP 2.

In a first case, for the transmit link, the terminal device reports the carrier 1, the carrier 2, and the carrier 3, which corresponds to Embodiment 1-1.

In a second case, for the transmit link, the terminal device reports the carrier 1 and the carrier 3, which corresponds to Embodiment 1-2.

For the first case or the second case, the network device determines the reference DC position corresponding to the transmit link in the same method as the terminal device. For example, a specific position between the lowest frequency of the carrier 1 and the highest frequency of the carrier 3, for example, an intermediate frequency position of the lowest frequency of the carrier 1 and the highest frequency of the carrier 3 is determined as the reference DC position corresponding to the transmit link, such as the DC position 1 in FIG. 10.

In a third case, for the transmit link, the terminal device reports the carrier 1 and the carrier 2, which corresponds to Embodiment 2-1 or Embodiment 2-2.

Furthermore, the network device determines the reference DC position corresponding to the transmit link in the same method as the terminal device.

For example, a specific position between the lowest frequency of the carrier 1 and the highest frequency of the carrier 2 (for example, an intermediate frequency position) is determined as the reference DC position corresponding to the transmit link, such as the DC position 2 in FIG. 10.

In a fourth case, for the transmit link, the terminal device reports the BWP 1 to BWP 4, which corresponds to Embodiment 3-1.

In a fifth case, for the transmit link, the terminal device reports the BWP 1 and the BWP 3, which corresponds to Embodiment 3-2.

For the fourth case or the fifth case, the network device determines the reference DC position corresponding to the transmit link in the same method as the terminal device. For example, the network device determines a specific position between the lowest frequency of the BWP 1 and the highest frequency of the BWP 3 (for example, an intermediate frequency position) as the reference DC position corresponding to the transmit link, such as the DC position 3 in FIG. 10.

In a sixth case, for the transmit link, the terminal device reports the BWP 4 and the BWP 2, which corresponds to Embodiment 4-1 or Embodiment 4-2.

For the sixth case, the network device determines the reference DC position corresponding to the transmit link in the same method as the terminal device.

For example, the network device determines a specific position between the lowest frequency of the BWP 1 and the highest frequency of the BWP 2 (for example, a middle frequency position) as the reference DC position corresponding to the transmit link, such as the DC position 4 in FIG. 10.

In some embodiments, the uplink transmission and the downlink reception of the terminal device share the DC position. In this case, the target carriers include the uplink carrier and the downlink carrier, and the target BWPs include the uplink BWP and the downlink BWP.

In some embodiments, the uplink transmission and the downlink reception of the terminal device do not share the DC position. In this case, for the uplink transmission, the target carrier includes the uplink carrier, and the target BWP includes the uplink BWP; for the downlink reception, the target carrier includes the downlink carrier, and the target BWP includes the downlink BWP.

In some embodiments, the method 200 further includes:
transmitting, by the terminal device, first capability information to the network device, wherein the first capability information indicates whether the terminal device supports report of the DC position in the CA, and/or indicates the number of the DC positions supported by the terminal device, and/or indicates that the terminal device supports the plurality of transmit links, and/or indicates that the terminal device supports the plurality of DC positions.

In some embodiments, the first capability information is transmitted over any uplink message or uplink signaling, for example, the uplink RRC message, the MAC signaling, the PUCCH, and the like, which is not limited in the present disclosure.

In summary, the terminal device reports the target carriers and/or the target BWPs for determining the reference DC positions corresponding to the plurality of transmit links to the network device. Furthermore, the network device determines the reference DC positions corresponding to the plurality of transmit links based on the target carriers and/or the target BWPs corresponding to the plurality of transmit links, and then determines the target DC positions corresponding to the plurality of transmit links in conjunction with the DC position offsets corresponding to the plurality of transmit links.

In some embodiments, in the case that the target carriers and/or the target BWPs of the reference DC positions corresponding to the plurality of transmit links are reported, the terminal device does not need to report the target carriers or the target BWPs corresponding to the plurality of transmit links again in response to the method for determining the reference DC positions corresponding to the plurality of transmit links being not adjusted, or the terminal device does not report the DC position offsets in response to the actually used DC positions being the reference DC positions, or the terminal device only needs to report the frequency offsets of the adjusted DC positions relative to the reference DC positions in response to the method for determining the reference DC positions corresponding to the plurality of transmit links being not adjusted and the actually used DC positions being adjusted, such that the signaling payload is reduced.

The embodiments of the method in the present disclosure are described in detail above in conjunction with FIGS. 8 to 10, and the apparatus embodiments in the present disclosure are described in detail hereinafter in conjunction with FIGS. 11 to 15. It should be understood that the apparatus embodiments correspond to the method embodiments, and for similar descriptions, reference may be made to the method embodiments.

FIG. 11 is a schematic block diagram of a terminal device 400 according to some embodiments of the present disclosure. As shown in FIG. 11, the terminal device 400 includes:

a communication unit 410, configured to transmit first information to a network device, wherein the first information includes target carriers and/or target BWPs corresponding to a plurality of transmit links of the terminal device, wherein the target carriers and/or the target BWPs corresponding to the plurality of transmit links are configured to determine reference DC carrier positions corresponding to the plurality of transmit links.

In some embodiments, the first information further includes information indicating a number of the plurality of transmit links.

In some embodiments, the target carriers corresponding to the plurality of transmit links include all carriers supported by the plurality of transmit links in carriers configured in the terminal device.

In some embodiments, the target carriers corresponding to the plurality of transmit links include carriers with a lowest frequency and carriers with a highest frequency in all carriers supported by the plurality of transmit links in carriers configured in the terminal device.

In some embodiments, the target carriers corresponding to the plurality of transmit links include all carriers supported by the plurality of transmit links in carriers configured and activated in the terminal device.

In some embodiments, the target carriers corresponding to the plurality of transmit links include carriers with a lowest frequency and carriers with a highest frequency in all carriers supported by the plurality of transmit links in carriers configured and activated in the terminal device.

In some embodiments, the target BWPs corresponding to the plurality of transmit links include all BWPs supported by the plurality of transmit links in BWPs configured in the network device.

In some embodiments, the target BWPs corresponding to the plurality of transmit links include BWPs with a lowest frequency and BWPs with a highest frequency in all BWPs supported by the plurality of transmit links in BWPs configured in the network device.

In some embodiments, the target BWPs corresponding to the plurality of transmit links include all BWPs supported by the plurality of transmit links in BWPs configured and activated in the network device.

In some embodiments, the target BWPs corresponding to the plurality of transmit links include BWPs with a lowest frequency and BWPs with a highest frequency in all BWPs supported by the plurality of transmit links in BWPs configured and activated in the network device.

In some embodiments, the communication unit 410 is further configured to:
transmit second information to the network device, wherein the second information includes DC carrier position offsets corresponding to the plurality of transmit links, wherein the DC carrier position offsets corresponding to the plurality of transmit links indicate frequency offsets of target DC carrier positions used in the plurality of transmit links by the terminal device relative to the reference DC carrier positions corresponding to the plurality of transmit links.

In some embodiments, the above communication unit is a communication interface or a transceiver, or a communication chip or an input output interface of a system on chip.

It should be understood that the terminal device 400 in the embodiments of the present disclosure corresponds to the terminal device in the method embodiments, and the above and other operations and/or functions of various units of the terminal device 400 achieve the corresponding processes of the terminal device in the methods 200 shown in FIG. 8 to FIG. 10, which are not described herein again for brevity.

FIG. 12 is a schematic block diagram of a network device according to some embodiments of the present disclosure. The network device 500 in FIG. 12 includes:
a communication unit 510, configured to receive first information from a terminal device, wherein the first information includes target carriers and/or target bandwidth parts (BWPs) corresponding to a plurality of transmit links of the terminal device, wherein the target carriers and/or the target BWPs corresponding to the plurality of transmit links are configured to determine reference direct current (DC) carrier positions corresponding to the plurality of transmit links.

In some embodiments, the first information further includes information indicating a number of the plurality of transmit links.

In some embodiments, the target carriers corresponding to the plurality of transmit links include all carriers supported by the plurality of transmit links in carriers configured in the terminal device.

In some embodiments, the target carriers corresponding to the plurality of transmit links include carriers with a lowest frequency and carriers with a highest frequency in all carriers supported by the plurality of transmit links in carriers configured in the terminal device.

In some embodiments, the target carriers corresponding to the plurality of transmit links include all carriers supported by the plurality of transmit links in carriers configured and activated in the terminal device.

In some embodiments, the target carriers corresponding to the plurality of transmit links include carriers with a lowest frequency and carriers with a highest frequency in all carriers supported by the plurality of transmit links in carriers configured and activated in the terminal device.

In some embodiments, the target BWPs corresponding to the plurality of transmit links include all BWPs supported by the plurality of transmit links in BWPs configured in the network device.

In some embodiments, the target BWPs corresponding to the plurality of transmit links include BWPs with a lowest frequency and BWPs with a highest frequency in all BWPs supported by the plurality of transmit links in BWPs configured in the network device.

In some embodiments, the target BWPs corresponding to the plurality of transmit links include all BWPs supported by the plurality of transmit links in BWPs configured and activated in the network device.

In some embodiments, the target BWPs corresponding to the plurality of transmit links include BWPs with a lowest frequency and BWPs with a highest frequency in all BWPs supported by the plurality of transmit links in BWPs configured and activated in the network device.

In some embodiments, the communication unit 510 is further configured to:
receive second information from the terminal device, wherein the second information includes DC carrier position offsets corresponding to the plurality of transmit links, wherein the DC carrier position offsets corresponding to the plurality of transmit links indicate frequency offsets of target DC carrier positions used in the plurality of transmit links by the terminal device relative to the reference DC carrier positions corresponding to the plurality of transmit links.

In some embodiments, the network device 500 further includes:
a processing unit, configured to determine the target DC carrier positions used in the plurality of transmit links by the terminal device based on the reference DC carrier positions corresponding to the plurality of transmit links and the DC carrier position offsets corresponding to the plurality of transmit links.

In some embodiments, the above communication unit is a communication interface or a transceiver, or a communication chip or an input output interface of a system on chip. The above processing unit includes one or more processors.

It should be understood that the terminal device 500 in the embodiments of the present disclosure corresponds to the terminal device in the method embodiments, and the above and other operations and/or functions of various units of the terminal device 500 achieve the corresponding processes of the terminal device in the methods 200 shown in FIG. 8 to FIG. 10, which are not described herein again for brevity.

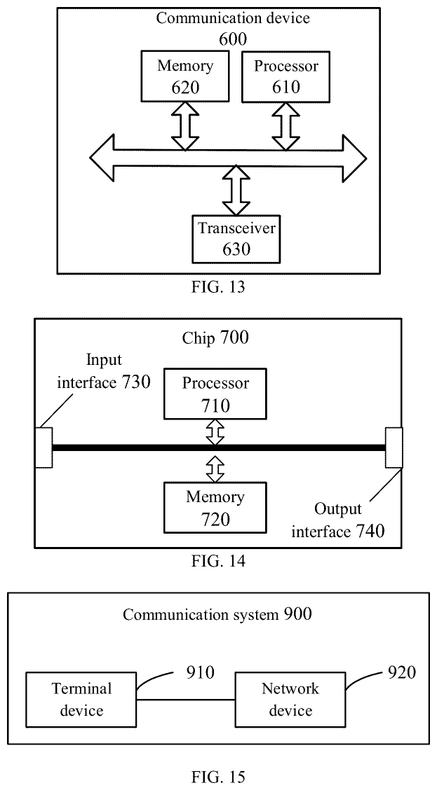

FIG. 13 is a schematic block diagram of a communication device 600 according to some embodiments of the present disclosure. The communication device 600 shown in FIG. 13 includes a processor 610. The processor 610, when loading and running one or more computer programs in a memory, is caused to perform the methods according to the embodiments of the present disclosure.

In some embodiments, as shown in FIG. 13, the communication device 600 further includes a memory 620. The processor 610, when loading and running one or more computer programs in the memory 620, is caused to perform the methods according to the embodiments of the present disclosure.

The memory 620 is a device separate from the processor 610, or is integrated in the processor 610.

In some embodiments, as shown in FIG. 13, the communication device 600 further includes a transceiver 630. The processor 610 controls communication of the transceiver 630 with other devices. In particular, the transceiver 630 transmits information or data to other devices, or receives information or data from other devices.

The transceiver 630 includes a transiter and a receiver. The transceiver 630 further includes one or more antennas.

In some embodiments, the communication device 600 is the network device in the embodiments of the present disclosure, and performs the corresponding processes performed by the network device in the methods according to of the present disclosure, which are not described hercin again for brevity.

In some embodiments, the communication device 600 is the mobile terminal/terminal device according to the embodiments of the present disclosure, and performs the corresponding processes performed by the mobile terminal/terminal device in the methods according to the embodiment of the present disclosure, which are not described herein again for brevity.

FIG. 14 is a schematic block diagram of a chip according to some embodiments of the present disclosure. The chip 700 shown in FIG. 14 includes a processor 710. The processor 710, when loading and running one or more computer programs in a memory, is caused to perform the methods according to the embodiments of the present disclosure.

In some embodiments, as shown in FIG. 14, the chip 700 further includes a memory 720. The processor 710, when loading and running one or more computer programs in the memory 720, is caused to perform the methods according to the embodiments of the present disclosure.

The memory 720 is a device separate from the processor 710, or is integrated in the processor 710.

In some embodiments, the chip 700 further includes an input interface 730. The processor 710 controls communication of the input interface 730 with other devices. In particular, the input interface 730 acquires information or data from other devices.

In some embodiments, the chip 700 further includes an output interface 740. The processor 710 controls communication of the output interface 740 with other devices. In particular, the output interface 740 transmits information or data to other devices.

In some embodiments, the chip 700 is applicable to the network device in the embodiments of the present disclosure, and perform the corresponding processes practiced by the network device in the methods according to the embodiments of the present disclosure, which are not described herein again for brevity.

In some embodiments, the chip 700 is applicable to the mobile terminal/terminal device in the embodiments of the present disclosure, and performs the corresponding processes practiced by the mobile terminal/terminal device in the methods according to the embodiment of the present disclosure, which are not described herein again for brevity.

It should be understood that the chip in the embodiments of the present disclosure is also referred to as a system-level chip, a system chip, a chip system, a system-on-chip, or the like.

FIG. 15 is a schematic block diagram of a communication system 900 according to some embodiments of the present disclosure. As shown in FIG. 15, the communication system 900 includes a terminal device 910 and a network device 920.

The terminal device 910 is configured to implement the corresponding functions implemented by the terminal device in the above methods, and the network device 920 is configured to implement the corresponding functions practiced by the network device in the above method, which are not described herein again for brevity.

It should be understood that the processor in the embodiments of the present disclosure is an integrated circuit chip with a signal processing capability. In the implementations, the processes in the method embodiments are achieved by integrated logic circuits of hardware in the processor or instructions in the software form. The above processor is a general processor, a digital signal processor (DSP), an application-specific integrated circuit (ASIC), a field-programmable gate array (FPGA), other programmable logic devices, discrete gates, transistor logic devices, or discrete hardware assemblies that can achieve or perform various methods, processes, and logic blocks according to the embodiments of the present disclosure. The general processor is a microprocessor, any conventional processor, or the like. The processes in conjunction with the method in the embodiments of the present disclosure are directly embodied as a hardware decoding processor for processing or are performed by a combination of hardware and software modules in the decoding processor. The software modules are disposed in a random access memory, a flash memory, a read-only memory, a programmable read-only memory, an electrically erasable programmable memory, a register, and other storage medium mature in the field. The storage medium is disposed in the memory, and the processor reads the information in the memory and combines with its hardware to perform the processes of the above method.

It should be understood that the memory in embodiments of the present disclosure is a volatile or non-volatile memory, or includes both the volatile memory and the non-volatile memory. The non-volatile memory is a read-only memory (ROM), a programmable ROM (PROM), an crasable PROM (EPROM), an electrically EPROM (EEPROM), or a flash memory. The volatile memory is a random access memory (RAM) used as an external cache. By way of example but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), and a direct rambus RAM (DR RAM). It should be noted that the system and the memory described herein are intended to include, but not limit to these and any other suitable type of memories.

It should be understood that the above memory is exemplary but not for limitation. For example, the memory in the embodiments of the present disclosure is also an SRAM, a DRAM, an SDRAM, a DDR SDRAM, an ESDRAM, an SLDRAM, a DR RAM, or the like. That is, the memory in the embodiments of the present disclosure is intend to include, but not limit to these and any other suitable type of memory.

Embodiments of the present disclosure further provide a computer-readable storage medium for storing one or more computer programs.

In some embodiments, the computer-readable storage medium is applicable to the network device in the embodiments of the present disclosure, and the one or more computer programs cause the computer to perform the corresponding processes practiced by the network device in the methods according to the embodiments of the present disclosure, which are not described herein again for brevity.

In some embodiments, the computer-readable storage medium is applicable to the mobile terminal/terminal device in the embodiments of the present disclosure, and the one or more computer programs cause the computer to perform the corresponding processes practiced the mobile terminal/terminal device in the methods according to the embodiments of the present disclosure, which are not described herein again for brevity.

Embodiments of the present disclosure further includes a computer program product including one or more computer program instructions.

In some embodiments, the computer program product is applicable to the network device in the embodiments of the present disclosure, and the one or more computer program instructions, when loaded and executed by a computer, cause the computer to perform the corresponding processes practiced by the network device in the methods according to the embodiments of the present disclosure, which are not described herein again for brevity.

In some embodiments, the computer program product is applicable to the mobile terminal/terminal device in the embodiments of the present disclosure, and the one or more computer program instructions, when loaded and executed by a computer, cause the computer to perform the corresponding processes practiced by the mobile terminal/terminal device in the methods according to the embodiments of the present disclosure, which are not described herein again for brevity.

Embodiments of the present disclosure further provide a computer program.

In some embodiments, the computer program is applicable to the network device in the embodiments of the present disclosure, and the computer program, when loaded and run on a computer, causes the computer to perform the corresponding processes practiced by the network device in the methods according to the embodiment of the present disclosure, which are not described herein again for brevity.

In some embodiments, the computer program is applicable to the mobile terminal/terminal device in the embodiments of the present disclosure, and the computer program, when loaded and run on a computer, causes the computer to perform the corresponding processes practiced by the mobile terminal/terminal device in the methods according to the embodiments of the present disclosure, which are not described herein again for brevity.

It can be understood by those of ordinary skill in the art that the units and algorithmic processes of the examples described in conjunction with the embodiments disclosed herein can be achieved by the electronic hardware, or by a combination of the computer software and the electronic hardware. Whether these functions are implemented by the hardware or the software depends on the specific application and design constraints of the technical solution. For cach application, those skilled in the art may use different methods to achieve the described functions, and such implementations should not be considered beyond the scope of the present disclosure.

It can be understood by those skilled in the art that for the specific operation processes of the system, device, and unit described above, reference may be made to the corresponding processes in the above embodiments of the method for convenience and simplicity of description, which are not repeated herein.

In the embodiments of the present disclosure, it should be understood that the systems, devices, and methods can be implemented in other ways. For example, the above embodiments of the device are only exemplary. For example, the division of the units is only the logical function division, and the actual implementation may have another division. For example, several units or assemblies can be combined or integrated into another system, or some features can be ignored or not performed. In addition, the coupling, the direct coupling, or the communication connection between each other may be achieved by some interfaces, and an indirect coupling or communication connection between devices or units may be electrical, mechanical or in other form.

The units described as separate parts may or may not be physically separate, and the parts shown as the units may or may not be physical units. That is, the parts may be disposed in one place, or distributed in several network units. Some or all of the units can be selected according to actual needs to achieve the purpose of the technical solutions according to the embodiments.

In addition, the functional units in the embodiments of the present disclosure may be integrated in a processing unit or exist physically separately, or two or more units may be integrated in a unit.

In the case that the functions are achieved in the form of software functional units and sold or used as stand-alone products, the functions may be stored in a computer readable storage medium. Based on the understanding, the nature of the technical solutions of the present disclosure, the part contributed to the prior art, or the part of the technical solutions may be embodied in the form of a software product, and the software product is stored in a storage medium and includes a number of instructions for causing a computer device (which may be a personal computer, a server, a network equipment, or the like) to perform all or part of the processes of the method in various embodiments of the present disclosure. The above storage medium include: a U disk, a mobile hard disk, a ROM, a RAM, a disk, a disc, or other media that can store program codes.

Described above are merely specific embodiments of the present disclosure, and the scope of protection of the present disclosure is not limited. Any changes or replacements made within the technical scope of the present disclosure by those skilled in the art should be encompassed within the scope of protection of the present disclosure. thus, the scope of protection of the present disclosure shall prevail in the scope of protection of the claims.

1. A wireless communication method, comprising:
transmitting, by a terminal device, first information to a network device, wherein the first information comprises target carriers and/or target bandwidth parts (BWPs) corresponding to a plurality of transmit links of the terminal device, wherein the target carriers and/or the target BWPs corresponding to the plurality of transmit links are configured to determine reference direct current (DC) carrier positions corresponding to the plurality of transmit links.

2. The method according to claim 1, wherein the first information further comprises information indicating a number of the plurality of transmit links.

3. The method according to claim 1, wherein the target carriers corresponding to the plurality of transmit links comprise carriers with a lowest frequency and carriers with a highest frequency in all carriers supported by the plurality of transmit links in carriers configured in the terminal device.

4. The method according to claim 1, wherein the target carriers corresponding to the plurality of transmit links comprise all carriers supported by the plurality of transmit links in carriers configured and activated in the terminal device.

5. The method according to claim 1, wherein the target carriers corresponding to the plurality of transmit links comprise carriers with a lowest frequency and carriers with a highest frequency in all carriers supported by the plurality of transmit links in carriers configured and activated in the terminal device.

6. The method according to claim 1, wherein the target BWPs corresponding to the plurality of transmit links comprise BWPs with a lowest frequency and BWPs with a highest frequency in all BWPs supported by the plurality of transmit links in BWPs configured in the network device.

7. The method according to claim 1, further comprising:
transmitting, by the terminal device, second information to the network device, wherein the second information comprises DC carrier position offsets corresponding to the plurality of transmit links, wherein the DC carrier position offsets corresponding to the plurality of transmit links indicate frequency offsets of target DC carrier positions used in the plurality of transmit links by the terminal device relative to the reference DC carrier positions corresponding to the plurality of transmit links.

8. A terminal device, comprising:
a processor and a memory storing one or more computer programs, which when executed by the processor, cause the terminal device to:
transmit first information to a network device, wherein the first information comprises target carriers and/or target bandwidth parts (BWPs) corresponding to a plurality of transmit links of the terminal device, wherein the target carriers and/or the target BWPs corresponding to the plurality of transmit links are configured to determine reference direct current (DC) carrier positions corresponding to the plurality of transmit links.

9. The terminal device according to claim 8, wherein the first information further comprises information indicating a number of the plurality of transmit links.

10. The terminal device according to claim 8, wherein the target carriers corresponding to the plurality of transmit links comprise carriers with a lowest frequency and carriers with a highest frequency in all carriers supported by the plurality of transmit links in carriers configured in the terminal device.

11. The terminal device according to claim 8, wherein the target carriers corresponding to the plurality of transmit links comprise all carriers supported by the plurality of transmit links in carriers configured and activated in the terminal device.

12. The terminal device according to claim 8, wherein the target carriers corresponding to the plurality of transmit links comprise carriers with a lowest frequency and carriers with a highest frequency in all carriers supported by the plurality of transmit links in carriers configured and activated in the terminal device.

13. The terminal device according to claim 8, wherein the target BWPs corresponding to the plurality of transmit links comprise BWPs with a lowest frequency and BWPs with a highest frequency in all BWPs supported by the plurality of transmit links in BWPs configured in the network device.

14. The terminal device according to claim 8, wherein the one or more computer programs, when executed by the processor, further cause the terminal device to:
transmit second information to the network device, wherein the second information comprises DC carrier position offsets corresponding to the plurality of transmit links, wherein the DC carrier position offsets corresponding to the plurality of transmit links indicate frequency offsets of target DC carrier positions used in the plurality of transmit links by the terminal device relative to the reference DC carrier positions corresponding to the plurality of transmit links.

15. A network device, comprising:
a processor and a memory storing one or more computer programs, which when executed by the processor, cause the network device to:
receive, first information from a terminal device, wherein the first information comprises target carriers and/or target bandwidth parts (BWPs) corresponding to a plurality of transmit links of the terminal device, wherein the target carriers and/or the target BWPs corresponding to the plurality of transmit links are configured to determine reference direct current (DC) carrier positions corresponding to the plurality of transmit links.

16. The network device according to claim 15, wherein the target carriers corresponding to the plurality of transmit links comprise carriers with a lowest frequency and carriers with a highest frequency in all carriers supported by the plurality of transmit links in carriers configured in the terminal device.

17. The network device according to claim 15, wherein the target carriers corresponding to the plurality of transmit links comprise all carriers supported by the plurality of transmit links in carriers configured and activated in the terminal device.

18. The network device according to claim 15, wherein the target carriers corresponding to the plurality of transmit links comprise carriers with a lowest frequency and carriers with a highest frequency in all carriers supported by the plurality of transmit links in carriers configured and activated in the terminal device.

19. The network device according to claim 15, wherein the target BWPs corresponding to the plurality of transmit links comprise BWPs with a lowest frequency and BWPs with a highest frequency in all BWPs supported by the plurality of transmit links in BWPs configured in the network device.

20. The network device according to claim 15, wherein the one or more computer programs, when executed by the processor, further cause the network device to:
receive second information from the terminal device, wherein the second information comprises DC carrier position offsets corresponding to the plurality of transmit links, wherein the DC carrier position offsets corresponding to the plurality of transmit links indicate frequency offsets of target DC carrier positions used in the plurality of transmit links by the terminal device relative to the reference DC carrier positions corresponding to the plurality of transmit links.
